(19) United States
(12) Patent Application Publication
(10) Pub. No.: US 2005/0155037 A1
(43) Pub. Date: Jul. 14, 2005

(54) Systems and methods for providing a return value to an application program

(76) Inventors: Markus Klein, Frankenthal (DE); Kai-Michael Roesner, Stutensee-Blakenloch (DE); Karl Wagner, Speyer (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/011,049

(22) Filed: Dec. 15, 2004

(30) Foreign Application Priority Data
Dec. 18, 2003 (EP) 03028926.8

(51) Int. Cl. G06F 9/46

(52) U.S. Cl. 719/310

(57) ABSTRACT

A data processing system receives a first data object having a plurality of first data fields from an application programs. When the first data object is received, the data processing system generates a second data object. Initially, the second data object is empty and has a number of data fields with unique field names. Data is transferred from data fields of the first data object to data fields of the second data object having identical field names. A sub-set of the data fields of the second data object is identified and data that is transferred to data fields of the sub-set is used to select one of a plurality of data processing functions. The data that is transferred to the second data object is evaluated and a resulting value is returned to the application program.

This application is based upon and claims the benefit of priority from prior patent application EP 03028926.8 filed Dec. 18, 2003, the entire contents of which are expressly incorporated herein by reference.

### BACKGROUND

I. Technical Field

The present invention relates to the field of data processing, and more particularly to providing a return value to an application program.

II. Background Information

In many data processing systems a calling application program provides data to another program that evaluates the data and provides a return value back to the calling application program. FIG. 1 shows a schematic block diagram of a prior art data processing system 100.

For example, data processing system 100 includes application program 102 and evaluation program 104. Application program 102 can send function call 106 that contains data to evaluation program 104. This invokes evaluation program 104, which evaluates data contained in the function call 106 in order to provide a return value 108 back to application program 102.

Application program 102 and evaluation program 104 can be run on the same hardware or on different remote computers. In the latter case, a request-response protocol, such as hypertext transfer protocol (HTTP) can be used. When using HTTP, function call 106 is an HTTP request and return value 108 is communicated back from evaluation program 104 to application program 102 as a HTTP response.

Additionally, data processing system 100 can have various applications. For example application program 102 receives biometric data (e.g. from a biometric data acquisition module that is coupled to a CCD camera) and a user ID (e.g. from a chip card) and provides the biometric data and user ID to evaluation program 104 by means of function call 106. Evaluation program 104 evaluates the biometric data and calculates a confidence value that the person from which the biometric data has been acquired is in fact the person having the user ID as provided with function call 106. In other words, the return value is a confidence value that indicates the likelihood that the person from which the biometric data is acquired is the same as the person to which the user ID belongs. The confidence value is returned from evaluation program 104 to application program 102 as return value 108.

In another example, application program 102 provides measurement data to evaluation program 104, such as measurement data acquired by sensors or by manual entry from an ongoing process. An example of an ongoing process is a production process. The measurement data provided to evaluation program 104 by means of function call 106 is evaluated in order to determine an actual status of the ongoing process. The actual status is signalled back to the application program 102 by means of return value 108.

Another example for usage of data processing system 100 is for the purpose of valuation, e.g. cost and/or price determination, of one or a plurality of products. In this instance application program 102 provides data such as product quantity, used materials, or services to evaluation program 104 that performs a corresponding valuation. The result of the valuation is returned as return value 108 to application program 102.

A common disadvantage of data processing systems of the type as shown in FIG. 1 is a lack of flexibility both concerning the evaluation functions performed by the evaluation program and the data that can be considered when performing the evaluation functions. This lack of flexibility is also disadvantageous with regard to software re-use. Often, there is a one-to-one relationship between an application program and an evaluation program. The interface between the application program and the evaluation program is specific so that the evaluation program cannot be used by other application programs. This often results in a duplication of resources because a separate evaluation program is required for similar evaluation tasks. As a consequence, the available data processing resources are not used efficiently.

### SUMMARY

Consistent with the present invention, a data processing system is provided. The data processing system comprises: means for receiving a first data object from an application program, the first data object having a plurality of first data fields, each one of the first data fields having a unique field name; means for providing a second data object in response to receipt of the first data object, the second data object having a plurality of second data fields, each one of the second data fields having one of the unique field names; means for storing the unique field names of the second data object and for defining a sub-set of the second data fields; means for storing a plurality of data processing functions; means for transferring data from the first data fields to the second data fields having identical field names; means for selecting one of the plurality of data processing functions on the basis of the data that has been transferred to the sub-set of the second data fields; and means for executing a selected one of the data processing functions to provide a return value for the application program.

Also consistent with the present invention, a method for providing a return value to an application program using a data processing system is provided. The method comprises: storing unique field names in a data processing system; storing identifiers in the data processing system to identify a sub-set of the unique field names; storing a plurality of data processing functions in the data processing system; receiving a first data object from the application program, wherein the first data object includes a plurality of first data fields and at least a sub-set of the first data fields have the unique filed names; transferring data from the first data fields to the second data fields having identical field names; selecting one of the plurality of data processing functions on the basis of data that has been transferred to second data fields that have field names belonging to the sub-set; and executing a selected one of the data processing functions to provide a return value.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 shows a block diagram of a prior art data processing system;

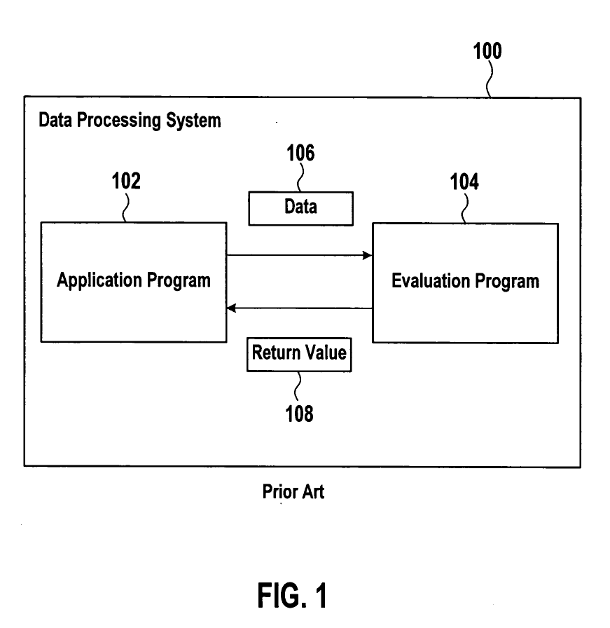

FIG. 2 shows a block diagram of an embodiment of a data processing system consistent with the present invention;

FIG. 3 shows a flow chart illustrating the operation of the data processing system shown in FIG. 2;

FIG. 4 shows a block diagram of another embodiment of a data processing system consistent with the present invention; and

FIG. 5 shows a flow chart illustrating operation of the data processing system shown in FIG. 4.

### DETAILED DESCRIPTION

The following detailed description refers to the accompanying drawings. Wherever possible, the same reference numbers are used in the drawings and the following description to refer to the same or similar parts.

The disclosed system provides a data processing system comprising means for receiving a first data object from an application program. The first data object has a plurality of first data fields. Each one of the first data fields has a unique field name. Further, the first data object may have data fields with other field names.

When the first data object is received by the data processing system, the data processing system generates a second data object. Initially, the second data object is empty and has a number of data fields with the unique field names as specified in the data processing system. Data is transferred from data fields of the first data object to data fields of the second data object having identical field names.

Further, a sub-set of the data fields of the second data object is identified in the data processing system. Data that is transferred to data fields of the sub-set is used for selecting one of a plurality of data processing functions stored by the data processing system. The data that is transferred to the second data object is evaluated by means of the selected one of the data processing functions and a resulting value is returned to the application program.

Consistent with the invention, the data fields belonging to the sub-set are key fields. The data processing functions are stored in a relational database having the same key fields. When data is transferred from the first data object to the second data object, the data entered into the key fields is used to query the database to select one of the data processing functions.

Consistent with the invention, a rule base is used to select one of the data processing functions. One or more of the rules of the rule base are applied to the data transferred to the sub-set of data fields of the second data object to select one of the data processing functions.

Consistent with the invention, at least one graphical user interface is provided to edit the unique field names, modify the sub-set, data processing functions, and/or the rule base.

The disclosed system provides a flexible data processing system that can be used by various application programs. Data consistency is provided by the definition of unique field names without further constraints. This semantic flexibility is combined with algorithmic flexibility regarding the data processing functions themselves and the selection logic of the data processing functions. This combination provides both user friendliness, flexibility, and the possibility of software reuse. In particular, the disclosed data processing system can be used for various application programs and various communication protocols across different technical platforms.

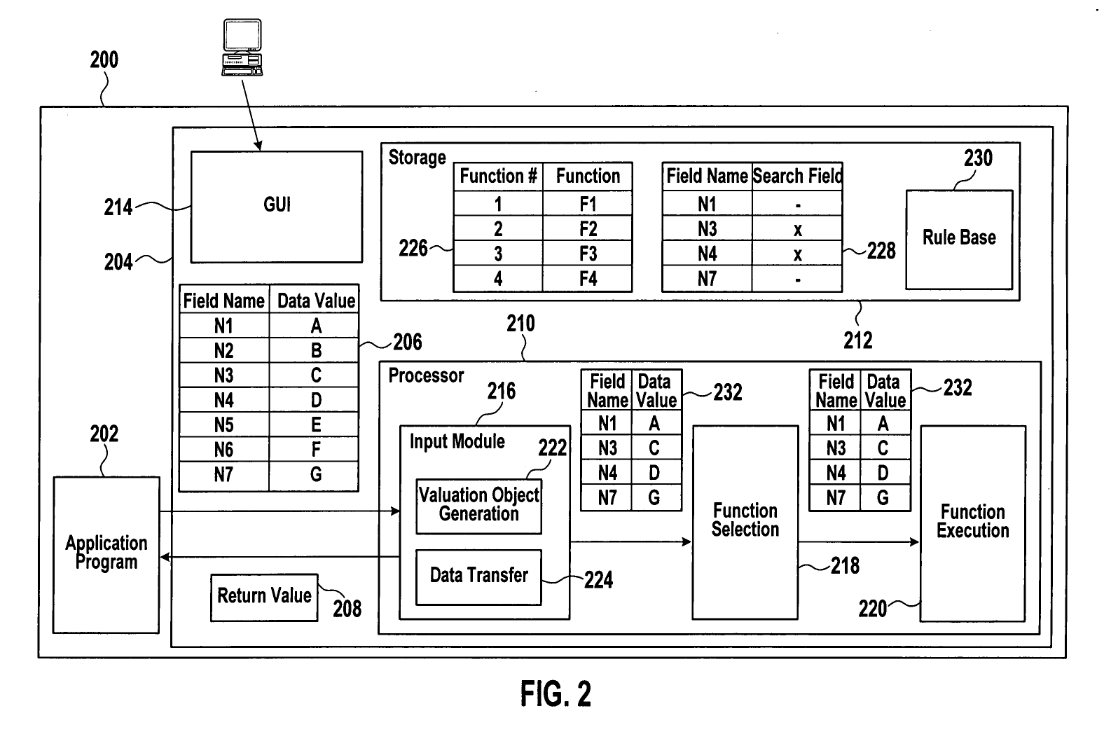

FIG. 2 shows a data processing system 200 having an application program 202 and an evaluation module 204. Application program 202 may or may not run on the same physical platform as evaluation module 204. For example, data processing system 200 is a single server computer for running both application program 202 and providing evaluation module 204. Alternatively, application program 202 can be executed on a remote computer that communicates with the server computer that provides evaluation module 204 over a network connection.

Evaluation module 204 includes a processor 210, a storage 212, and a graphical user interface (GUI) 214. Processor 210 may execute program modules 216, 218, and 220. Program module 216 receives a data object 206 from application program 202. Program module 216 includes a program module 222 that generates an empty data object, e.g. a valuation object, in response to receipt of a data object 206. Program module 216 also includes a program module 224 for transferring data from data object 206 into the initially empty valuation object.

Program module 218 allows for function selection of one of the data processing functions stored in a storage 212. Program module 220 executes the data processing function that has been selected by program module 218.

The data processing functions are stored in storage 212. In this example, the data processing functions F1, F2, F3, and F4 are stored in a table 226. The data processing functions can be entered and edited in table 226 by means of a graphical user interface 214.

In addition, a table 228 is stored in storage 212. Table 228 includes a list of unique field names N1, N3, N4, and N7. A sub-set of the unique field names is identified as search fields in table 228, i.e. field names N3 and N4 as shown in FIG. 2. This identification can be performed by storing a one bit identifier that identifies whether a given field name in the table 228 belongs or does not belong to the sub-set.

Data that is transferred into data fields having field names N3 and N4 is used by program module 218 for selection of the data processing function from table 226. This selection is performed by program module 218 by applying one or more rules of a rule base 230 to data that is transferred into the search fields N3 and/or N4. Table 228 and rules of rule base 230 can be entered and/or edited by means of graphical user interface 214.

In operation, application program 202 sends data object 206 to evaluation module 204. Data object 206 includes a number of data fields N1 to N7, some of which have field names contained in table 228. In response, program module 216 is invoked and program module 222 generates an initially empty valuation object 232 that is used for internal processing within evaluation module 204. Program module 224 transfers data values of data fields having identical field names from data object 206 to valuation object 232. In other words, program module 224 searches the field names of the data object 206 for field names that also exist in valuation object 232. When a field name in data object 206 is identified that also occurs in valuation object 232, the data value assigned to that field in data object 206 is copied into the field having the same field name in valuation object 232. Accordingly, valuation object 232 is filled with data values.

It is to be noted that the content of valuation object 232 is determined by table 228 in as far as table 228 specifies the unique field names of the data fields of valuation object 232. This semantic definition of the data fields by table 228 is used to transfer data from data object 206 to valuation object 232.

Valuation object 232 is entered into program module 218 that reads the data from the data fields of valuation object 232 that are identified as search fields in table 228. Further program module 218 applies one or more rules of rule base 230 to the data contained in the search fields of valuation object 232 in order to select one of the data processing functions from table 226. Next, valuation object 232 is entered into program module 220 to apply the selected data processing function to valuation object 232. The resulting value is returned as return value 208 to application program 202.

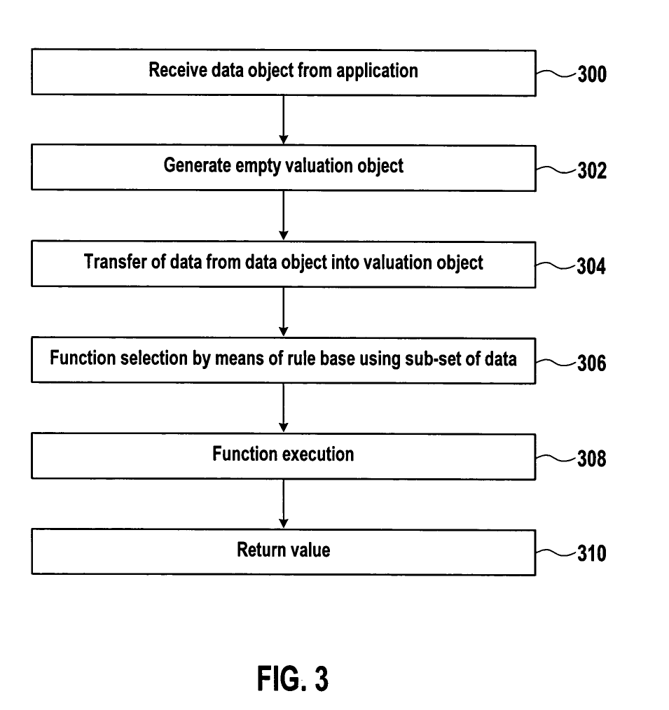

FIG. 3 shows a corresponding flow chart. In step 300, a data object is received from an application program. In response, an empty valuation object is generated in step 302. The data fields of the valuation object are determined by the unique field names that are stored in the data processing system. Next, the valuation object is filled with data from the data object by transferring data from data fields of the data object to data fields of the valuation object having identical names. Step 304.

In step 306, one of a plurality of data processing functions is selected on the basis of a sub-set of the data that has been transferred into the valuation object. This sub-set is defined by the corresponding entries, such as entries into “search field” of table 228 shown in FIG. 2. The selected data processing function is executed in step 308 using the data of valuation object 232 as input. The function output is provided as a return value to the application program in step 310.

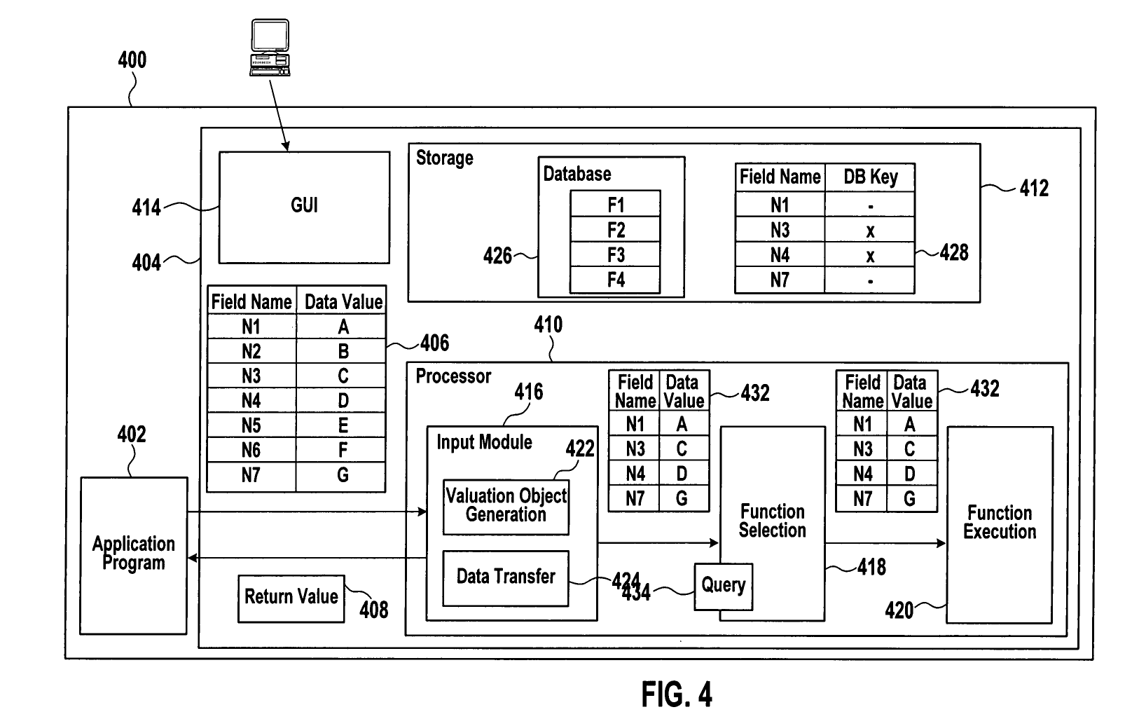

FIG. 4 shows another embodiment consistent with the present invention. Elements of FIG. 4 that correspond to elements of FIG. 2 are designated by like reference numerals. In the embodiment shown in FIG. 4, the data processing functions F1 to F4 are stored in a database 426. Database 426 includes database tables with primary keys that are identified in table 428 in row “DB key.” Program module 418 includes a program module 434 for querying database 426.

When program module 418 receives a valuation object 432, it uses the data entered into the data fields identified by the entries in row “DB key” as keys for performing a database query. In this example, the data values C and D of data fields N3 and N4 are used for querying database 426. The result of the database query is one of the data processing functions F1 to F4 that is executed by program module 420.

It is to be noted that an evaluation module consistent with the present invention can be used by various different application programs. The communication of the application programs with the evaluation module is based on the unique filed names stored in the storage of the data processing system.

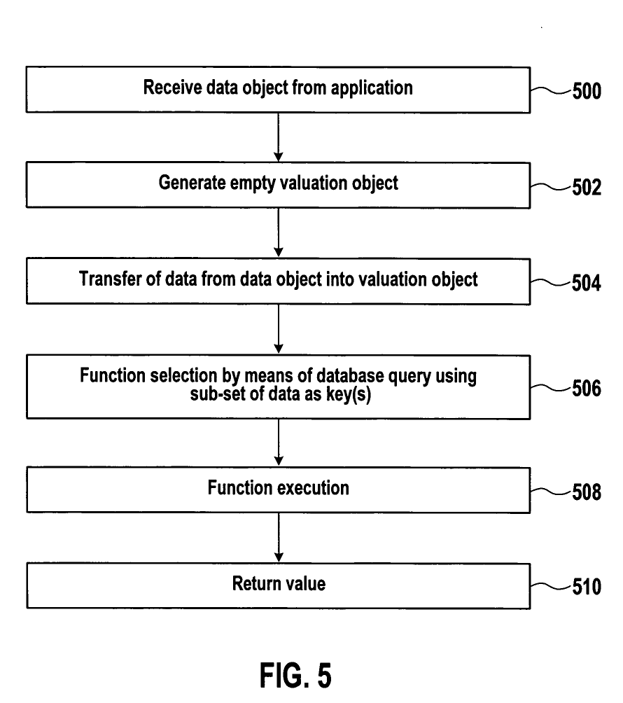

FIG. 5 shows a corresponding flow chart. Steps 500 to step 504 corresponds to steps 300 to 304 of the method of FIG. 3. In step 506, a database query is performed using the sub-set of the data fields identified by table 428 as keys. The data processing function which is thus identified is executed in step 508 and a return value is provided back to the application program in step 510.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

1. A data processing system comprising:
means for receiving a first data object from an application program, the first data object having a plurality of first data fields, the first data fields having unique field names;
means for providing a second data object in response to receipt of the first data object, the second data object having a plurality of second data fields, the second data fields having one of the unique field names;
means for storing the unique field names of the second data object and for defining a sub-set of the second data fields;
means for storing a plurality of data processing functions;
means for transferring data from the first data fields to the second data fields having identical field names;
means for selecting one of the plurality of data processing functions on the basis of the data that has been transferred to the sub-set of the second data fields; and
means for executing a selected one of the data processing functions to provide a return value for the application program.

2. The data processing system of claim 1, wherein the second data fields belonging to the sub-set are key fields, the plurality of data processing functions are stored in a relational database, and wherein the means for selecting one of the plurality of data processing functions is performed by querying the relational database by means of the data that has been transferred to the key fields.

3. The data processing system of claim 1, further comprising means for providing a rule base to select one of the plurality of the data processing functions by applying one or more of the rules stored in the rule base to the data that has been transferred to the sub-set of the second data fields.

4. The data processing system of claim 1, further comprising at least one graphical user interface for editing the unique field names or for editing the data processing functions.

5. The data processing system of claim 1, further comprising a plurality of application programs for sending a plurality of data objects to the means for providing a second data object, wherein each one of the data objects of the plurality application programs having data fields with the unique field names.

6. A method for providing a return value to an application program using a data processing system, the method comprising:
storing unique field names in a data processing system;
storing identifiers in the data processing system to identify a sub-set of the unique field names;
storing a plurality of data processing functions in the data processing system;
receiving a first data object from the application program, wherein the first data object includes a plurality of first data fields and at least a sub-set of the first data fields have the unique filed names;
transferring data from the first data fields to the second data fields having identical field names;
selecting one of the plurality of data processing functions on the basis of data that has been transferred to second data fields that have field names belonging to the sub-set; and
executing a selected one of the data processing functions to provide a return value.

7. The method of claim 6, wherein the second data fields that have field names belonging to the sub-set are key fields, the plurality of data processing functions are stored in a relational database, and the selection of one of the plurality of data processing functions is performed by querying the database using the data of the key fields.

8. The method of claim 7, further comprising providing a rule base, and using one or more rules of the rule base to selecting one of the plurality of data processing functions.

9. The method of claim 6, further comprising editing the unique field names, the data processing functions, or the rule base by means of a graphical user interface.

10. The method of claim 6, further comprising providing a plurality of application programs for sending the first data objects to the data processing system, each one of the first data objects having first data fields having the unique field names.

11. A computer program product for providing a return value to an application program for execution by a data processing system having means for storing unique field names and for identifying a sub-set of the unique field names, and means for storing a plurality of data processing functions, the computer program product comprising instructions for:
receiving a first data object from the application program, wherein the first data object includes a plurality of first data fields, the first data fields having one of the unique field names, and having further data fields having other field names;
providing a second data object in response to receipt of the first data object, the second data object having a plurality of second data fields, the second data fields having one of the unique field names;
transferring data from the first data fields of the first data objects to the second data fields having identical field names;
selecting one of the plurality of data processing functions on the basis of data that has been transferred to the second data fields having field names of the sub-set; and
executing a selected one of the data processing functions to provide the return value to the application program.

12. The computer program product of claim 11, wherein the second data fields having field names belonging to the sub-set are key fields, the plurality of data processing functions are stored in a relational database, and the selection of one of the plurality of data processing functions is performed by querying the database using the data of the key fields.

13. The computer program product of claim 11, wherein the data processing system further comprises providing a rule base, and the computer program product further comprises instructions for using one or more rules of the rule base for selecting one of the plurality of data processing functions.

14. The computer program product of claim 11, further comprising instructions for editing the unique field names, the data processing functions, or the rule base by means of a graphical user interface.

15. The computer program product of claim 11, further comprising providing a plurality of application programs for sending first data objects to the data processing system, each one of the first data objects having first data fields having the unique field names.
